(19) United States
(12) Patent Application Publication
(10) Pub. No.: US 2007/0228235 A1
(43) Pub. Date: Oct. 4, 2007

(54) Duct hoisting bracket

(76) Inventor: Nicholas Roccaforte, Morris Plains, NJ (US)

Correspondence Address: "MY GLASS", 6134 N MISSOURI, PORTLAND, OR, 97217, US

(21) Appl. No.: 11/708,726

(22) Filed: Feb. 20, 2007

Related U.S. Application Data
(60) Provisional application No. 60/789,094, filed on Apr. 4, 2006.

(51) Int. Cl. F16M 11/00

(52) U.S. Cl. 248/200

(57) ABSTRACT

In accordance with another aspect of the present invention, a bracket is provided for lifting one or more duct sections with a crane. Each of the duct sections has a flange with an opening. The bracket includes a base with a surface and a center point. The base also has one or more bolt receiving openings and one or more externally threaded bolts. Each of the bolts is received in a different one of the bolt receiving openings with at least a portion of the bolt extending beyond the surface of the base. An internally threaded nut is associated with each bolt and adapted to secure the flange of a duct section on the base, when the bolt is received through the flange opening of the duct section. The bracket also includes an eye bolt fixed to the base proximate the center point such that the crane may engage the eye bolt and lift the bracket with the attached duct sections.

### BACKGROUND OF THE INVENTION

1. Field of the Invention

The present invention relates to ducts for use in commercial and residential forced air heating and air conditioning systems and more particularly to a bracket for simultaneously hoisting a plurality of duct sections with a crane or the like.

2. Description of Prior Art Including Information Disclosed under 37 CFR 1.97 and 1.98

Air ducts made of sheet metal and plastic materials have long been used to transport forced air in commercial and residential heat and air conditioning systems from the furnace or air conditioning unit to and from various locations in the building. Because of the length and weight of the ducts, the ducts are commonly fabricated, transported to the construction site and installed in sections.

The ends of each section are provided with an outwardly protruding lip or flange. The flanges on adjacent duct sections are used to connect the sections together to form an air tight air circulation system.

Particularly in commercial buildings, but sometimes in residential construction as well, it is necessary to hoist the duct sections from the ground or truck bed to a higher location during installation of the duct system. A crane or similar automated lifting apparatus is often used for that purpose.

That is conventionally accomplished by attaching each individual duct section to the sling or hook of the crane and lifting the attached duct section to the desired location. Once it is in the desired location the section is removed from the crane, maneuvered into the desired position and joined to the adjacent section. That operation must be repeated for each section.

Because a building heating and air conditioning system can consist of many duct sections, the process of hoisting each section individually can involve considerable cost. It requires expensive crane time and many costly man hours to complete the task. It is therefore desirable to develop a system which can greatly reduce the cost involved in the duct section hoisting operation without sacrificing the safety of the workmen on the job.

### BRIEF SUMMARY OF THE INVENTION

It is, therefore, a prime object of the present invention to provide a duct hoisting bracket.

It is another object of the present invention to provide a duct hoisting bracket that greatly reduces the cost of hoisting multiple duct sections.

It is another object of the present invention to provide a duct hoisting bracket that greatly reduces the time necessary to hoist multiple duct sections.

It is another object of the present invention to provide a duct hoisting bracket that does not increase the safety risks involved with the hoisting multiple duct sections.

It is another object of the present invention to provide a duct hoisting bracket that is inexpensive to fabricate and easy to use.

It is another object of the present invention to provide a duct hoisting bracket that operates reliably and has a long useful life.

In general, those objects are achieved in the present invention through the use of a bracket adapted to attach to a crane that is capable of simultaneously engaging multiple duct sections such that they can be hoisted together in a safe and efficient manner. This is accomplished using a simple bracket structure that is simple, easy and safe to use.

In accordance with one aspect of the present invention, a bracket is provided for lifting one or more duct sections with a crane. Each of the duct sections has a flange. The bracket includes a base. Means are provided for attaching the flange of each of the duct sections to the base. The base has means adapted to be engaged by the crane. Accordingly, the crane may engage the bracket to lift the attached duct sections.

Each of the flanges has an opening. The flange attaching means includes a shaft on the base adapted to be received in the flange opening. The shaft extends beyond the surface of the base. Means are provided for securing the flange on the shaft. Preferably, the shaft takes the form of an externally threaded bolt and the securing means is an internally threaded nut adapted to be received on the bolt.

The bracket has a plurality of corners. A different flange attaching means is situated proximate each corner.

Preferably, the means adapted to be engaged by the crane takes the form of an eye bolt. The bracket has a center point. The eye bolt is attached to the base proximate the center point.

In accordance with another aspect of the present invention, a bracket is provided for lifting one or more duct sections with a crane. Each of the duct sections has a flange with an opening. The bracket includes a base with a surface and a center point. The base also has one or more internally threaded bolt receiving openings and one or more externally threaded bolts. Each of the bolts is received in a different one of the bolt receiving openings with at least a portion of the bolt extending beyond the surface of the base. An internally threaded nut is associated with each bolt and adapted to secure the flange of a duct section on the base, when the bolt is received through the flange opening of the duct section. The bracket also includes an eye bolt fixed to the base proximate the center point such that the crane may engage the eye bolt and lift the bracket with the attached duct sections.

The base is substantially planar and rectangular and thus has more than one corner. A bolt receiving opening is provided proximate each of the base corners. A bolt is provided for each bolt receiving opening.

### BRIEF DESCRIPTION OF THE SEVERAL VIEWS OF DRAWINGS

To these and to such other objects that may hereinafter appears, the present invention relates to a duct hoisting bracket, as described in detail in the following specification and recited in the annexed claims, taken together with the accompanying drawings, in which like numerals refer to like parts and in which:

FIG. 1 is an environmental view showing a crane lifting multiple duct sections with the bracket of the present invention;

FIG. 2 is an isometric view of a typical duct section showing the flanges;

FIG. 3 is an elevation view showing the top of the bracket of the present invention:

FIG. 4 is an elevation view showing the side of the bracket of the present invention:

FIG. 5 is an elevation view showing the top of the bracket of the present invention with four duct sections attached; and

FIG. 6 is an elevation view showing the side of the bracket of the present invention with four duct sections attached.

### DETAILED DESCRIPTION OF THE INVENTION

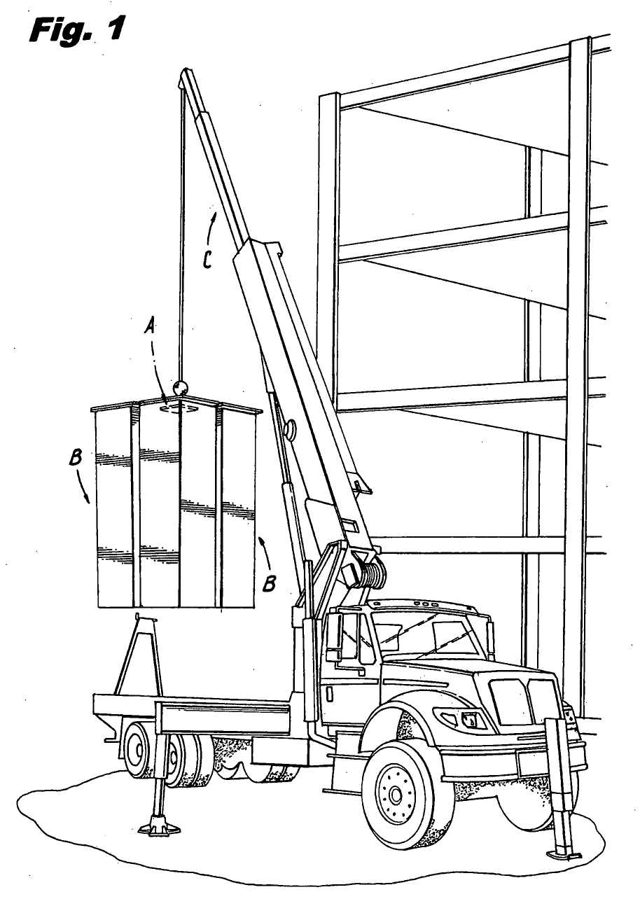

As illustrated in FIG. 1, the bracket of the present invention, generally designated A, is designed to engage one or more duct sections, generally designated B, and be lifted by a crane, generally designated C, to an elevated platform such as the roof of a building.

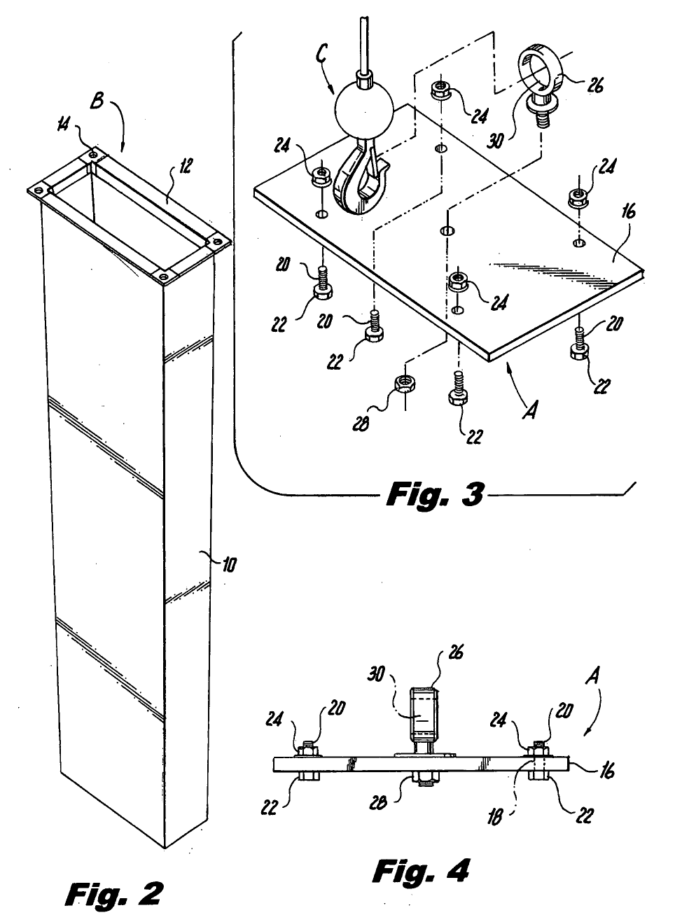

FIG. 2 illustrates a typical duct section B. Duct section B is usually formed of sheet metal, although other materials may be used. It consists of a conduit 10 with a rectangular cross-sectional shape, although other shapes, such as circular are also sometimes employed. At least one end of conduit 10 has an outwardly extending flange 12 which permits the duct sections to be connected. The flange has at least one opening 14 situated at the corner. A flange 12 with an opening 14 at each corner is illustrated. In the present invention, the flange 12 is also use as a means of attaching the duct section to bracket A.

The structure of bracket A may be understood by reference to FIGS. 3 and 4. Those figures show that the bracket consists of a generally rectangular base 16, preferably formed of metal such as steel. Proximate each corner of base 16 is an opening 18 adapted to receive an externally threaded bolt 20 with a head 22. Head 22 is situated adjacent the bottom surface of base 18 such that the shaft of the bolt extends above the top surface of the base. An internally threaded safety nut 24 is provided for each bolt. Nuts 24 are received on the shaft of the bolts in order to secure the duct sections to the bracket, as explained below.

Base 16 has a center point. An eye bolt 26 is inserted through an opening at the base center point and secured to the bracket by a threaded nut 28 or by similar part welded to the bottom surface of the base. Eye bolt 26 has an opening 30 which is designed to be engages by the hook or sling of crane C.

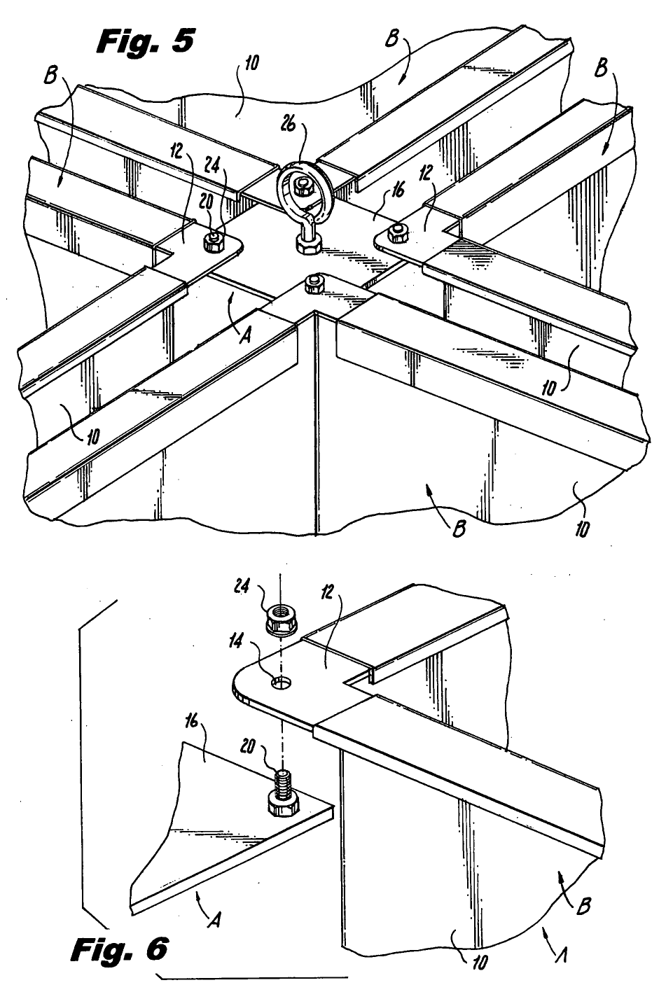

Referring now to FIGS. 5 and 6, with nuts 24 removed form bolts 22, one corner of a flange 12 of as many as four duct sections B may be attached to the bracket by aligning the opening 14 in the corner of each flange 12 with a different one of the bolts 22 and causing the exposed shaft of the bolt to be received in the flange opening 14. Thereafter, nuts 24 are screwed onto the bolts so as to secure the duct sections to the bracket.

With the duct sections secured, the hook or sling of the crane C engages eye bolt 26 and the bracket with secured duct sections can be simultaneously lifted by the crane onto the building roof. Once on the roof, the duct sections are detached from the bracket by removing nuts 24 so that the flanges are disengaged and the bracket is lowered by the crane to pick up the next set of duct sections.

It will now be appreciated that the present invention relates to bracket for lifting one or more duct sections with a crane. Each of the duct sections has a flange with an opening. The bracket includes a base with a surface and a center point. The base also has one or more bolt receiving openings and one or more externally threaded bolts. Each of the bolts is received in a different one of the bolt receiving openings with at least a portion of the bolt extending beyond the surface of the base. An internally threaded nut is associated with each bolt and adapted to secure the flange of a duct section on the base, when the bolt is received through the flange opening of the duct section. The bracket also includes an eye bolt fixed to the base proximate the center point such that the crane may engage the eye bolt and lift the bracket with the attached duct sections.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims.

I claim:

1. A bracket for lifting one or more duct sections with a crane, each of the duct sections having a flange, said bracket comprising, a base, means for attaching the flange of each duct section to said base and means on said base adapted to be engaged by the crane, such that the crane may engage and lift said bracket and the attached duct sections.

2. The bracket of claim 1 wherein the flange has an opening and wherein said flange attaching means comprises a shaft extending from said base adapted to be received in the flange opening.

3. The bracket of claim 2 further comprising means for securing the flange on said shaft.

4. The bracket of claim 1 wherein said base has a surface and wherein said flange attaching means comprises a shaft extending from said base and extending beyond said surface.

5. The bracket of claim 4 further comprising an internally threaded nut adapted to be received on said shaft.

6. The bracket of claim 4 wherein said shaft comprises a bolt.

7. The bracket of claim 6 wherein said base has an opening into which said bolt is adapted to be received.

8. The bracket of claim 1 wherein said bracket has a plurality of corners and further comprising flange attaching means proximate each corner.

9. The bracket of claim 1 wherein said means adapted to be engaged by the crane comprises an eye bolt.

10. The bracket of claim 9 wherein said bracket has a center point and said eye bolt is attached to said base proximate said center point.

11. A bracket for lifting one or more duct sections with a crane, each of the duct sections having a flange with an opening, said bracket comprising a base with a surface and a center point, one or more bolt receiving openings, one or more externally threaded bolts, each of said bolts being received in a different one of said bolt receiving openings with at least a portion of the bolt extending beyond said base surface, an internally threaded nut associated with each bolt and adapted to secure the flange of a duct section on said base, when said bolt is received through the flange opening of the duct section, an eye bolt fixed to said base proximate said center point such that the crane may engage the eye bolt and lift the bracket with the attached duct sections.

12. The bracket of claim 11 wherein said base is substantially planar.

13. The bracket of claim 11 wherein said base is substantially rectangular.

14. The bracket of claim 11 wherein said base comprises more than one corner and a bolt receiving opening is provided proximate each of said corners.

15. The bracket of claim 14 further comprising a bolt for each bolt receiving opening.
